(19) United States
(12) Patent Application Publication
(10) Pub. No.: US 2005/0266753 A1
(43) Pub. Date: Dec. 1, 2005

(54) Textile treatment and resulting textile

(76) Inventors: Xinggao Fang, Duncan, SC (US); Zeb W. Atkinson, Boiling Springs, SC (US); Edwin R. Lee, Gaffney, SC (US)

Correspondence Address: Charlotte C. Wilson, Legal Department, M-495, PO Box 1926, Spartanburg, SC, 29304, US

(21) Appl. No.: 10/853,944

(22) Filed: May 26, 2004

(51) Int. Cl. B32B 3/00

(52) U.S. Cl. 442/76; 442/59

(57) ABSTRACT

The present disclosure relates to a textile treatment and the treated textile, wherein one side of the textile is treated to have hydrophobic characteristics and the other side is treated to have both hydrophobic and oleophobic characteristics. The present treatment is wash-durable and breathable. The textile treatment is effective at repelling aqueous liquids (such as rain) and at preventing the penetration of oily liquids (such as chemical warfare agents) through the textile.

### TECHNICAL FIELD

The present disclosure relates to a textile treatment and the treated textile, wherein one side of the textile substrate is treated to have hydrophobic characteristics and the other side is treated to have primarily oleophobic characteristics. The present treatment is wash-durable and breathable. The textile treatment is effective at repelling aqueous liquids (such as rain) and at preventing the penetration of organic, oily liquids (such as chemical warfare agents) through the textile substrate.

### SUMMARY

A textile substrate is treated on one side with a hydrophobic treatment and on the opposite side with a treatment that imparts primarily oleophobic characteristics. The hydrophobic treatment is imparted by the application at least one of waxes, silicones, acrylic copolymers, polyester dispersions, polyolefin dispersions, hydrophobically modified inorganic particulates (including nano-particulates), and combinations thereof. The oleophobic treatment is imparted by the application of oleophobic chemicals such as fluorochemicals. When incorporated into a garment, the treated textile substrate is capable of preventing toxic organic materials from reaching the wearer of the garment.

### DETAILED DESCRIPTION

The term “hydrophobic,” as used herein, is intended to describe a surface that is not capable of uniting with or absorbing water.

The term “oleophobic,” as used herein, is intended to describe a surface that is not capable of uniting with or absorbing oil.

One anticipated use of the treated textile substrate described herein is as an outer layer for a protective garment, which would typically be used in connection with an inner layer that contains activated carbon. The treatment applied to the textile substrate provides a hydrophobic surface to the outer surface of the garment. The hydrophobic surface repels water from the garment, thereby protecting the activated carbon from liquid contamination.

Further, oily compounds are absorbed by the hydrophobic surface of the textile substrate. However, because the opposite side of the textile substrate is oleophobic, the oily compounds cannot pass through the textile. The oily compound is instead spread over, and absorbed into, the textile substrate. By dispersing the oily compound over a larger surface area on the textile substrate, the vapors of the oily compound are similarly diffused over a larger surface area of activated carbon present in the inner layer of the protective garment.

Although intended for use in protective apparel for the military (where the oily compound may be a nerve agent), it is anticipated that the treated textile could also be used in aprons; protective apparel for chemical, industrial, and food service applications; and textile wipes for a variety of purposes.

The textile substrate is constructed from natural or synthetic fibers, filaments, or yarns, or blends thereof. For example, the textile substrate may be comprised of fibers or yarns made from commonly available materials such as nylon, polyester, polypropylene, acrylic, olefins such as polyethylene and polypropylene, cellulosic materials (e.g., rayon or cotton), blends thereof, and other materials having a synthetic or natural construction. It should be understood that the discussion of any specific polymer herein is intended to include not only homopolymers, but also co-polymers thereof.

The selected yarn (or yarns, if different types are used) optionally may be dyed, as where accent yarns in the final product are desired or where yarns particularly suited to solution dyeing (e.g., polypropylene) are used. The yarns may be textured or untextured, depending on the desired appearance of the treated textile product.

Possible constructions of the textile substrate include various types of weaving and knitting, as well as the use of non-woven constructions. The textile substrate can be printed or dyed before application of the treatments described herein. In addition, the textile substrates can be treated mechanically (such as by sanding or brushing) to create a surface that mimics those of leaves, such as lotus or rice.

Although not wishing to be bound by theory, it is contemplated that the dual surface treatment described herein could be applied to non-textile substrates (e.g., paper substrates, which can be broadly categorized as nonwoven materials). Such non-textile articles may be useful for a variety of products, particularly where the treated article is considered disposable.

The water repellent property of the substrate is created by the application of one or more hydrophobic finishes, such as waxes, silicones, and acrylic copolymers. Examples of waxes suitable for use in this application include a zirconium wax sold by Consols Inc. of Charlotte, N.C., under the tradename CONSOPEL ZW; an aluminum wax sold by Cognis of Cincinnati, Ohio, under the tradename REPELLAN HY-N; a wax sold by Rudolf-Venture Chemical of Rock Hill, S.C., under the tradename RUCO-DRY DHY; and a wax sold by Noveon, Inc. of Cleveland, Ohio, under the tradename FREEPEL 1225. Of these, FREEPEL 1225 wax has been found to work particularly well. One example of an acrylic copolymer suitable for use in this application is an acrylic copolymer sold by Rohm & Haas of Spring House, Pa., under the tradename EMULSION E-940. One example of a silicone suitable for use in this application is a silicone sold by Kelmar Industries of Duncan, S.C., under the tradename FINISH WS 60E.

The hydrophobic finish is applied to one or both sides of the textile substrate, using application methods such as padding, coating, spraying, and foam coating. Foam coating is generally preferred because of the ability to control the level of add-on and depth of penetration. The hydrophobic finish is applied at add-on levels in the range of between about 1% and about 20% based on the weight of the textile substrate and, more preferably, between about 1% and about 10%.

To one side of the textile substrate, an oleophobic finish is applied. Fluorochemicals are particularly good at providing oleophobic properties to the textile substrate. Examples of such fluorochemicals include a fluorochemical sold by Ciba Specialty Chemical of High Point, N.C., under the tradename ZONYL 7713; fluorochemicals sold by Mitsubishi International Corporation of New York, N.Y. under the tradenames REPEARL F35 and REPEARL F7000; fluorochemicals sold by Daikin America Corporation of Mobile, Ala., under the tradenames UNIDYNE TG571 and UNIDYNE TG470. Of these, REPEARL F35 fluorochemical has been found to work particularly well. Alternatively, the oleophobic finish can be created by the application of oleophobic microporous materials, such as TEFLON® films, to the textile substrate. In this instance, that is, the use of microporous oleophobic films, the treated textile would be breathable. Lastly, the oleophobic surface could be calendered to offer increased resistance to oil penetration.

The oleophobic finish is applied to only one side of the textile substrate, using application methods as were described above. The oleophobic finish is applied at add-on levels in the range of between about 0.1% and about 20% of the weight of the textile substrate and, more preferably, between about 0.5% and about 10%.

One application method is to apply the hydrophobic treatment to one side of the textile substrate, followed by application of the oleophobic treatment. Another technique is to apply the hydrophobic and oleophobic treatment simultaneously, using, for example, a two-sided foam coater.

Crosslinking agents, such as epoxides, melamines, and blocked isocyanates, can be incorporated into either of the finishes to increase their wash durability. Crosslinking agents are generally added at levels of between about 0.01% to about 10% of the weight of the textile substrate and, more prefereably, between about 0.05% to about 5%. Further, small particulates (such as nanoparticles) could be applied to the textile substrate to create a certain physical structure, either before the substrate is treated as described herein or as part of the treatment. Such structure may enhance the hydrophobic surface properties of the textile substrate.

In addition, small amounts of oleophobic fluorochemicals can be included in the hydrophobic formulation to increase the durability of the hydrophobic properties to laundering and to adjust the repellency properties of the treated substrate. Typically, the amount of oleophobic material added is at levels of between about 0.02% to about 5% of the weight of the textile substrate.

Likewise, adding hydrophobic components to the oleophobic finish allows the manufacturer to adjust the treated textile substrate's repellency and durability. Typically, the amount of hydrophobic material added is at levels of between about 0.1% to about 10% of the weight of the textile substrate.

Once the finishes have been applied to the textile substrate, the treated textile is dried for between 30 seconds and ten minutes in an oven at temperatures between about 250° F. and 400° F.

### Test Methods

Water Repellency

AATCC Spray Test 22-1985 was used to evaluate the water repellency of the treated textile.

Oil Absorbency and Pass-Through Resistance

To evaluate the treated textile's ability to absorb oil while resisting pass-through, a test was created, using AATCC Water Resistance Impact Penetration Test Method 42-1985 as a model. The newly devised test method included the following steps.
1. Paper cardboard and the textile substrate were cut into 8-inch by 8-inch squares and weighed.
2. The textile substrate was placed on top of the cardboard, and the two layers were clamped together to a metal plate, which was tilted at an angle of 45 degrees. The center of the fabric was approximately on the center of the metal plate.
3. The dispensing end of a funnel was positioned about 9 inches above the center of the metal plate. 100 mL of oily liquid was then poured into the funnel to be dispensed onto the textile/cardboard assemblage. In this test, methyl salicylate was used as the oily liquid.
4. After all of the liquid was dispensed onto the textile substrate, the textile/cardboard assemblage was carefully removed from the metal plate. The textile substrate was separated from the cardboard and shaken several times in air to remove excess sticking liquid drops.
5. The textile substrate and the cardboard were both reweighed. The weight gains were calculated and recorded.
   Washing/Drying

The textile substrate was washed in a 35-pound Milnor front-load washing machine, with a total load of 30 pounds of textile, using type 2 laundry detergent P-D-245F from Iso-Parts Corporation of Indian Harbor Beach, Fla.

The following wash cycles were used:

WASHING PROCEDURE

| | Time | Temperature | | Detergent Usage / |
|---|---|---|---|---|
| Operation | (minutes) | (° F.) | Water Level | 30 lb. load |
| Break | 6 | 110 | High | 85 g |
| Wash | 2 | 110 | High | 51 g |
| Rinse | 2 | 90 | High | |
| Rinse | 2 | 90 | High | |
| Rinse | 2 | 90 | High | |
| Extract | 5 | n/a | n/a | |
| (low speed) | | | | |

After each wash, the textile substrate was dried in a 50-pound gas dryer for 30 minutes at a “Low Delicates” setting (about 120° F.), followed by a 5-minute cool-down period.

### EXAMPLES

The following Examples were conducted using a woven textile substrate having a plain-weave rip-stop construction with 52/48 nylon/combed cotton yarns in both the warp and fill and a standard weight of 6.30 ounces/square yard.

Unless otherwise specified, the aqueous compositions were applied to the textile substrate, using a Gaston System Lab Foamer.

The composition formulations are based on weight percentage, unless otherwise specified.

The textile substrate described above exhibited a weight pick-up of each composition of about 10% by weight, unless otherwise specified.

### Example 1

The hydrophobic composition, described below, was applied to the face side of the textile substrate.

Hydrophobic Composition

| | | |
|---|---|---|
| A. | RUCO-DRY DHY wax | 30% |
| B. | ARKOPHOB DAN cross-linking agent | 10% |
| C. | MYKON NRW3 foaming agent | 3% |

The oleophobic composition, described below, was applied to the back of the textile substrate.

Oleophobic Composition

| | | |
|---|---|---|
| A. | ZONYL 7713 fluorochemical | 20% |
| B. | ARKOPHOB DAN cross-linking agent | 15% |
| C. | MYKON NRW3 foaming agent | 3% |

The foamed textile substrate was dried in an oven at 350° F. for about 2 minutes. The treated textile was then washed and dried six times, using the procedure described above.

### Example 2

The hydrophobic composition, described below, was applied to the face side of the textile substrate.

Hydrophobic Composition

| | | |
|---|---|---|
| A. | FREEPEL 1225 wax | 22.5% |
| B. | ARKOPHOB DAN cross-linking agent | 9.0% |
| C. | MYKON NRW3 foaming agent | 1.5% |

The oleophobic composition, described below, was applied to the back of the textile substrate.

Oleophobic Composition

| | | |
|---|---|---|
| A. | REPEARL F35 fluorochemical | 10% |
| B. | ARKOPHOB DAN cross-linking agent | 5% |
| C. | MYKON NRW3 foaming agent | 1.5% |

The foamed textile substrate was dried in an oven at 350° F. for about 2 minutes. The treated textile was then washed and dried six times, using the procedure described above.

### Example 3

The hydrophobic composition, described below, was applied to the face side of the textile substrate.

Hydrophobic Composition

| | | |
|---|---|---|
| A. | FREEPEL 1225 wax | 12.5% |
| B. | ARKOPHOB DAN cross-linking agent | 5.5% |
| C. | MYKON NRW3 foaming agent | 1.2% |
| D. | REPEARL F35 fluorochemical | 1.5% |

The oleophobic composition, described below, was applied to the back of the textile substrate.

Oleophobic Composition

| | | |
|---|---|---|
| A. | REPEARL F35 fluorochemical | 10% |
| B. | ARKOPHOB DAN cross-linking agent | 5% |
| C. | MYKON NRW3 foaming agent | 1.5% |

The foamed textile substrate was dried in an oven at 350° F. for about 2 minutes. The treated textile was then washed and dried six times, using the procedure described above.

### Example 4

In this example, the weight pick-up was about 6.8% by weight.

The hydrophobic composition, described below, was applied to the face side of the textile substrate.

Hydrophobic Composition

| | | |
|---|---|---|
| A. | FREEPEL 1225 wax | 17% |
| B. | ARKOPHOB DAN cross-linking agent | 8.0% |
| C. | MYKON NRW3 foaming agent | 1.5% |
| D. | REPEARL F35 fluoroohemical | 1.7% |

The oleophobic composition, described below, was applied to the back of the textile substrate.

Oleophobic Composition

| | | |
|---|---|---|
| A. | REPEARL F35 fluorochemical | 11% |
| B. | ARKOPHOB DAN cross-linking agent | 8% |
| C. | MYKON NRW3 foaming agent | 1.4% |

The foamed textile substrate was dried in an oven at 350° F. for about 2.5 minutes. The treated textile was then washed and dried six times, using the procedure described above.

### Example 5

### Comparative

The sample textile substrate used in Examples 1-4 was used in this example. The textile substrate was immersed into an aqueous mixture containing the components described below.

Hydrophobic/Oleophobic Composition

| | | |
|---|---|---|
| A. | CONSOPEL ZW wax | 6% |
| B. | REPEARL F7000 fluorochemical | 2% |
| C. | ARKOPHOB DAN cross-linking agent | 1% |
| D. | Water | 91% |

The textile substrate was then nipped between two rolls at 40 p.s.i. to remove moisture. The textile substrate exhibited a wet pick-up of about 65%. The treated substrate was dried in an oven at 350° F. for about 4.5 minutes. The treated textile substrate was then washed and dried six times, using the procedure described above.

### Example 6

### Comparative

The sample textile substrate used in Examples 1-4 was used in this example. The textile substrate was immersed into an aqueous mixture containing the components described below.

Hydrophobic Composition

| | | |
|---|---|---|
| A. | FREEPEL 1225 wax | 6% |
| B. | ARKOPHOB DAN cross-linking agent | 1% |
| C. | Water | 93% |

The textile substrate was then nipped between two rolls at 40 p.s.i. to remove excess moisture. The textile substrate exhibited a wet pick-up of about 65% by weight of the textile substrate. The treated substrate was dried in an oven at 350° F. for about 4.5 minutes. The treated textile substrate was then washed and dried six times, using the procedure described above.

### Example 7

### Comparative

The sample textile substrate used in Examples 1-4 was used in this example. The textile substrate was immersed into an aqueous mixture (weight on weight) containing the components described below.

Hydrophobic/Oleophobic Composition

| | | |
|---|---|---|
| A. | FREEPEL 1225 wax | 6% |
| B. | REPEARL F35 fluorochemical | 2% |
| C. | ARKOPHOB DAN cross-linking agent | 1% |
| C. | Water | 91% |

The textile substrate was then nipped between two rolls at 40 p.s.i. to remove excess moisture. The textile substrate exhibited a wet pick-up of about 65%. The treated substrate was dried in an oven at 350° F. for about 4.5 minutes. The treated textile substrate was then washed and dried six times, using the procedure described above.

### Example 8

### Comparative

The sample textile substrate used in Examples 1-4 was used in this example. The textile substrate was immersed into an aqueous mixture (weight on weight) containing the components described below.

Oleophobic Composition

| | | |
|---|---|---|
| A. | REPEARL F735 fluorochemical | 10% |
| B. | ARKOPHOB DAN cross-linking agent | 2.5% |
| C. | Water | 87.5% |

The textile substrate was then nipped between two rolls at 40 p.s.i. to remove excess moisture. The textile substrate exhibited a wet pick-up of about 65%. The treated substrate was dried in an oven at 350° F. for about 4.5 minutes. The treated textile substrate was then washed and dried six times, using the procedure described above.

### Evaluation of Examples

The water repellency of the Example textile substrates was evaluated using AATCC Spray Test 22-1985. The test scores are described below, as are the test results for each of the four Examples.

As defined by the AATCC Test Method, the Spray Test Ratings are defined as follows.

| | |
|---|---|
| Rating of 100: | No sticking or wetting of upper surface. |
| Rating of 90: | Slight random sticking or wetting of upper surface. |
| Rating of 80: | Wetting of upper surface at spray points. |
| Rating of 70: | Partial wetting of whole of upper surface. |
| Rating of 50: | Complete wetting of whole of upper surface. |
| Rating of 0: | Complete wetting of whole upper and lower surfaces. |

WATER REPELLENCY: Examples 1 - 4

| | Example 1 | Example 2 | Example 3 | Example 4 |
|---|---|---|---|---|
| Before washing | 80 | 100 | 100 | 100 |
| After 6 washes | 50 | 80 | 90 | 80 |

These results indicate that the treated textile substrates have good water repellency that is durable to laundering.

This test was also conducted using the treated textile substrates of Comparative Examples 5-8. The results are shown below.

WATER REPELLENCY: Comparative Examples 5 - 8

| | Example 5 | Example 6 | Example 7 | Example 8 |
|---|---|---|---|---|
| Before washing | 100 | 100 | 100 | 100 |
| After 6 washes | 50 | 80 | 100 | 90 |

In particular, the treated substrate of Example 5 showed significantly less water repellency after 6 washes.

The textile substrate's ability to absorb oil and resist its pass-through was evaluated using the procedure described above, where the values represent the % pick-up of the textile substrate. For each Example fabric, the test was conducted before washing and after six washes. The results are shown below.

OIL ABSORBENCY AND PASS-THROUGH TEST
(“Oily” chemical used: methyl salicylate)

| | Example 1 | Example 2 | Example 3 | Example 4 |
|---|---|---|---|---|
| | % pick-up of Textile Substrate | | | |
| Before washing | 22.3 | 15.2 | 12.9 | 16.3 |
| After 6 washes | 31.0 | 19.1 | 19.5 | 34.5 |
| | % pick-up of Cardboard | | | |
| Before treated textile | 0 | 0 | 0 | 0.9 |
| was washed | | | | |
| After treated textile | 0 | 0 | 0 | 0.3 |
| was washed 6 times | | | | |

All textile substrates treated to have both hydrophobic and oleophobic surfaces exhibited good oil absorbency and simultaneous resistance to oil pass-through that is durable to laundering.

The results (particularly for Examples 1-3) further indicate that, although the treated textiles absorbed up to about 31% by weight of the oily chemical, the dual surface treatment was successful in preventing the migration of the oily chemical to the surface beneath the textile substrate (i.e., the cardboard).

This test was also conducted for the Comparative Examples 5-8, before washing and after 6 washes as described. The results are shown below.

OIL ABSORBENCY AND PASS-THROUGH TEST
(“Oily” chemical used: methyl salicylate)

| | Example 5 | Example 6 | Example 7 | Example 8 |
|---|---|---|---|---|
| | % pick-up of Textile Substrate | | | |
| Before washing | 14.4 | 38.8 | 11.9 | 12.9 |
| After 6 washes | 33.6 | 48.2 | 12.7 | 12.1 |
| | % pick-up of Cardboard | | | |
| Before treated textile | 0 | 35.4 | 0 | 0 |
| was washed | | | | |
| After treated textile | 6.6 | 29.2 | 0 | 0 |
| was washed 6 times | | | | |

These results show that Examples 5 and 6 did not perform well in terms of oil pass-through.

In these Examples, the combination of hydrophobic and oleophobic treatments (Example 5) and the hydrophobic treatment alone (Example 6) each allowed oil to pass-through the textile substrate.

By comparison, Examples 7 and 8 showed textile substrates that exhibited relatively poor absorption of oil. The pass-through rate was negligible due to the relatively low levels of oil that were absorbed.

1. A process for treating a textile substrate comprising the steps of:
(a) providing a textile substrate having a first surface and a second surface;
(b) applying a hydrophobic treatment to at least the first surface of said textile substrate; and
(c) applying an oleophobic treatment to the second surface of said textile substrate.

2. The process of claim 1, wherein said oleophobic treatment primarily comprises a fluorocarbon.

3. The process of claim 2, wherein said oleophobic treatment is applied at add-on levels of between about 0.1% and about 10% of the weight of the textile substrate.

4. The process of claim 2, wherein said oleophobic treatment further comprises a cross-linking agent.

5. The process of claim 2, wherein said oleophobic treatment further comprises a hydrophobic component, said hydrophobic component being present in an amount of between about 0.1% to about 10% of the weight of the textile substrate.

6. The process of claim 1, wherein said hydrophobic treatment comprises at least one of the compounds selected from the group consisting of waxes, silicones, acrylic copolymers, polyester dispersions, polyolefin dispersions, and hydrophobically modified inorganic particulates.

7. The process of claim 6, wherein said hydrophobic treatment comprises a wax.

8. The process of claim 6, wherein said hydrophobic treatment is applied at add-on levels of between about 1% and about 20% of the weight of the textile substrate.

9. The process of claim 6, wherein said hydrophobic treatment further comprises a cross-linking agent.

10. The process of claim 6, wherein said hydrophobic treatment further comprises an oleophobic component, said oleophobic component being present in an amount between about 0.02% about about 5% of the weight of said textile substrate.

11. The process of claim 1, wherein step (b) and step (c) occur simultaneously.

12. A textile substrate comprising first and second surfaces, wherein said first surface has a hydrophobic treatment and said second surface has primarily an oleophobic treatment.

13. The textile substrate of claim 12, wherein said oleophobic treatment primarily comprises a fluorocarbon.

14. The textile substrate of claim 13, wherein said oleophobic treatment is applied at add-on levels of between about 0.1% and about 10% of the weight of the textile substrate.

15. The textile substrate of claim 13, wherein said oleophobic treatment further comprises a cross-linking agent.

16. The textile substrate of claim 13, wherein said oleophobic treatment further comprises a hydrophobic component, said hydrophobic component being present in an amount of between about 0.1% to about 10% of the weight of the textile substrate.

17. The textile substrate of claim 12, wherein said hydrophobic treatment comprises at least one of the compounds selected from the group consisting of waxes, silicones, acrylic copolymers, polyester dispersions, polyolefin dispersions, and hydrophobically modified inorganic particulates.

18. The textile substrate of claim 17, wherein said hydrophobic treatment comprises a wax.

19. The textile substrate of claim 17, wherein said hydrophobic treatment is applied at add-on levels of between about 1% and about 20% of the weight of the textile substrate.

20. The textile substrate of claim 17, wherein said hydrophobic treatment further comprises a cross-linking agent.

21. The textile substrate of claim 17, wherein said hydrophobic treatment further comprises an oleophobic component, said oleophobic component being present in an amount between about 0.02%, about about 5% of the weight of said textile substrate.
